(19) United States
(12) Patent Application Publication
(10) Pub. No.: US 2016/0004242 A1
(43) Pub. Date: Jan. 7, 2016

(54) LADDER-PROGRAM DISPLAY PROGRAM AND LADDER-PROGRAM DISPLAY APPARATUS

(71) Applicants: Takayuki YAMAOKA, (US); Hiroshi HAMAZAKI, (US)

(72) Inventors: Takayuki YAMAOKA, Tokyo (JP); Hiroshi HAMAZAKI, Tokyo (JP)

(73) Assignee: MITSUBISHI ELECTRIC CORPORATION, Chiyoda-ku, Tokyo (JP)

(21) Appl. No.: 14/766,809

(22) PCT Filed: Mar. 7, 2013
(86) PCT No.: PCT/JP2013/056328

§ 371 Date: Aug. 10, 2015

(51) Int. Cl. G05B 19/05

(52) U.S. Cl. CPC G05B 19/056

(57) ABSTRACT

A ladder-program display program that causes a computer to execute: a hierarchical data retaining step of storing a ladder program in a form of a data structure representation that expresses the ladder program by a logical hierarchical structure by expressing each circuit block, which is a hierarchical unit of the ladder program, by a logical expression; and a display processing step of causing, on a basis of the data structure representation, the ladder program to be displayed on a display device in a form of a data structure representation or a ladder diagram in which each hierarchical unit of the hierarchical structure is visually capable of being identified.

### Field

The present invention relates to a ladder-program display program and a ladder-program display apparatus that display circuits in a ladder program.

### BACKGROUND

Ladder programs are programs that define a control sequence performed by a sequencer and are written in the form of ladder diagrams. In a ladder diagram, a circuit diagram is written such that it resembles a ladder with two vertical buses (positive bus and negative bus) at both ends symbolically expressing power. The flow of power in a relay circuit is illustrated on the parallel lines that connect the two buses in a horizontal direction. When such a ladder program is displayed or edited, a dedicated ladder-program display and edit apparatus is used.

Conventional ladder-program display and edit apparatuses display buses forming a ladder program and a two-dimensional grid in which auxiliary lines are drawn in a checkerboard pattern in the ladder-program display area on the screen. Then, the conventional ladder-program display and edit apparatuses display the ladder program such that components (circuit elements) of the ladder program, such as circuit components, an example of which is a contact, and connection lines, are arranged in the cells in the two-dimensional grid (for example, see Patent Literature 1).

In conventional technologies, when a ladder program is displayed, the frame border (cursor) that indicates a currently selected portion is indicated by a color different from the background color, thereby identifying the selected portion (for example, see Patent Literature 2).

A ladder program represents a relay circuit and has a structure in which series and parallel circuits are hierarchically nested (logical hierarchical structure). Therefore, when a ladder program having a logical hierarchical structure is edited, it is necessary to recognize the position of the hierarchy of the currently selected portion in the entire ladder program.

The complexity generally increases as the size of the ladder program increases; therefore, the legibility of the entire ladder program decreases. Thus, there is a method of improving the legibility of the entire program by omitting the display of significant fixed partial programs (for example, individual functions and blocks).

### CITATION LIST

### Patent Literature

Patent Literature 1: Japanese Patent Application Laid-open No. 2005-092807

Patent Literature 2: Japanese Patent Application Laid-open No. 2011-086118

### SUMMARY

### Technical Problem

However, with the former and latter conventional technologies described above, it is difficult to recognize the hierarchical structure. Therefore, there are problems such as the efficiency of creating a ladder program having a hierarchical structure being reduced and faults being contained in the created ladder program because of the misreading of the hierarchical range.

Moreover, with the former and latter conventional technologies described above, because circuits are expressed in a two-dimensional grid, it is difficult to automatically recognize a significant circuit unit. Therefore, it is necessary that the ladder programmer manually specifies the program units that are to be displayed in an omitted manner, which is a time-consuming process.

The present invention has been achieved in view of the above and an object of the present invention is to obtain a ladder-program display apparatus and a ladder-program display program that display a program such that the hierarchical structure of the ladder program is easily visible.

### Solution to Problem

In order to solve the above problems and achieve the object, an aspect of the present invention is a ladder-program display program that causes a computer to execute: a hierarchical data retaining step of storing a ladder program in a form of a data structure representation that expresses the ladder program by a logical hierarchical structure by expressing each circuit block, which is a hierarchical unit of the ladder program, by a logical expression; and a display processing step of causing, on a basis of the data structure representation, the ladder program to be displayed on a display device in a form of a data structure representation or a ladder diagram in which each hierarchical unit of the hierarchical structure is visually capable of being identified.

### Advantageous Effects of Invention

According to the present invention, an effect is obtained where it becomes possible to display a program such that the hierarchical structure of the ladder program is easily visible.

### BRIEF DESCRIPTION OF DRAWINGS

FIG. 1 is a diagram illustrating the configuration of a ladder-program display apparatus according to a first embodiment.

FIG. 2 is a diagram for explaining a data structure representation of a ladder program.

FIG. 3 is a diagram for explaining a method of displaying a ladder diagram.

FIG. 4 is a diagram for explaining the color-coded indication process performed in hierarchical units.

FIG. 5 is a diagram illustrating the configuration of a ladder-program display apparatus according to a second embodiment.

FIG. 6 is a diagram for explaining the omission display process performed on a selection range.

FIG. 7 is a diagram illustrating the configuration of a ladder-program display apparatus according to a third embodiment.

FIG. 8 is a diagram for explaining the process of editing a ladder diagram in hierarchical units.

FIG. 9 is a diagram for explaining the process of editing a data structure representation in hierarchical units.

FIG. 10 is a diagram illustrating the configuration of a ladder-program display apparatus according to a fourth embodiment.

FIG. 11 is a diagram for explaining monitor display in hierarchical units.

FIG. 12 is a diagram illustrating the configuration of a ladder-program display apparatus according to a fifth embodiment.

FIG. 13 is a diagram illustrating the hardware configuration of a ladder-program display apparatus.

### DESCRIPTION OF EMBODIMENTS

A ladder-program display apparatus and a ladder-program display program according to embodiments of the present invention will be explained below in detail with reference to the drawings. This invention is not limited to the embodiments.

### First Embodiment

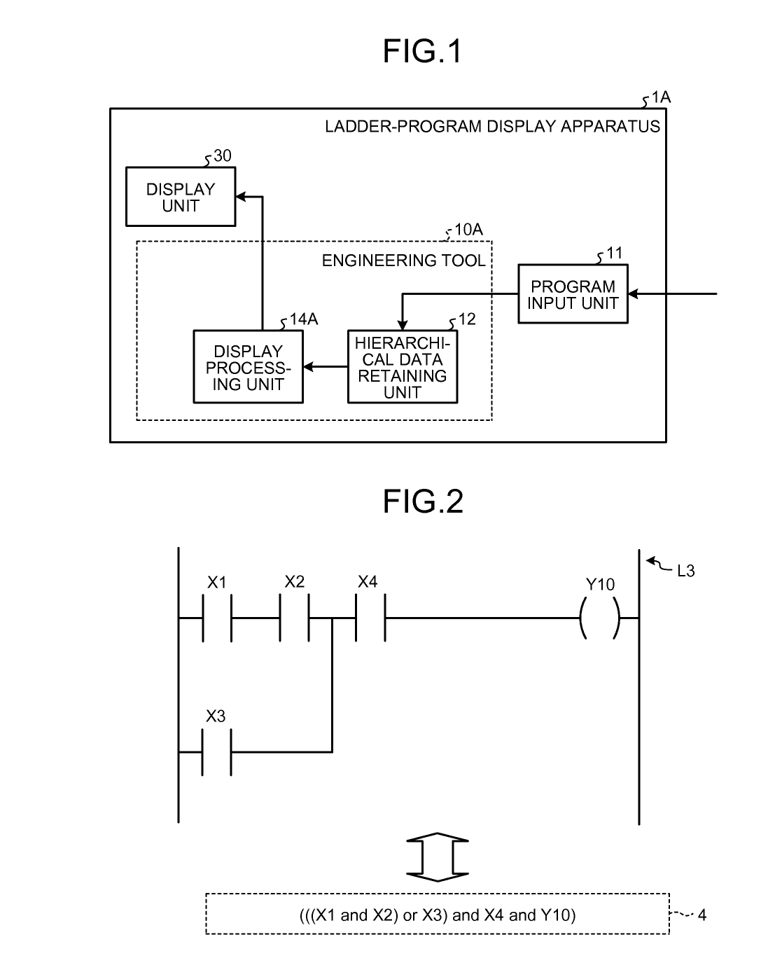

FIG. 1 is a diagram illustrating the configuration of a ladder-program display apparatus according to a first embodiment. A ladder-program display apparatus 1A is an apparatus that displays a ladder program and is, for example, a PC (Personal Computer). The ladder-program display apparatus 1A in the present embodiment displays a ladder program in a state where the hierarchical structure can be visually identified so that the circuit logical hierarchical structure is easily visible. The ladder-program display apparatus 1A displays a ladder program such that each hierarchy can be visually identified, for example, by displaying each hierarchy in a color-coded manner. The ladder programs to be displayed by the ladder-program display apparatus 1A are programs used in PLC (Programmable Logic Controller) (sequencer) systems or the like.

The ladder-program display apparatus 1A includes an engineering tool 10A, a program input unit 11, and a display unit 30. The program input unit 11 receives a ladder program created by a ladder-program creating apparatus or the like and sends it to the engineering tool 10A. In the present embodiment, the ladder-program display apparatus 1A displays a ladder diagram by using a data structure representation of the ladder program.

The data structure representation is obtained by logically describing each circuit block of a logical hierarchical structure of series and parallel circuits in a ladder program. In other words, the data structure representation expresses a ladder program by a logical hierarchical structure by expressing each circuit block, which is a hierarchical unit of the ladder program, by a logical expression. Specifically, the data structure representation is data in which circuits can be expressed only by a binary logical expression using only “and”, “or”, and “not”.

The engineering tool 10A is a tool for displaying a ladder program that is operated by a PLC system or the like. The engineering tool 10A can be realized, for example, as S/W (software) on a PC.

The engineering tool 10A includes a hierarchical data retaining unit 12 and a display processing unit 14A. The hierarchical data retaining unit 12 is, for example, a memory that stores therein a ladder program (data structure representation) that expresses a hierarchical structure.

The display processing unit 14A causes a ladder program to be displayed as a ladder diagram on the display unit 30 by using the data structure representation in the hierarchical data retaining unit 12. The display processing unit 14A in the present embodiment causes a ladder diagram to be displayed such that each hierarchy can be visually identified. For example, the display processing unit 14A displays a ladder program such that each hierarchy is displayed in a different color.

Next, the structure of a ladder program is explained. A ladder program can be expressed as a hierarchical structure of series and parallel circuits. In the present embodiment, a unit in a hierarchical structure in a ladder program is referred to as a hierarchical unit. The hierarchical unit is a significant fixed partial program (such as individual functions and blocks).

In the present embodiment, a basic element (such as one contact and one coil), which is treated as an indivisible element, is referred to as a circuit element. The circuit element is a minimum hierarchical unit. The hierarchical unit is a single-input, single-output. For example, when hierarchical units or circuit elements are connected in series, a series of hierarchical units or circuit elements connected in series is one hierarchical structure.

FIG. 2 is a diagram for explaining a data structure representation of a ladder program. A ladder program is created as a ladder diagram L3 or a data structure representation 4 as illustrated in FIG. 2. The ladder diagram L3 and the data structure representation 4 indicate the same ladder program; therefore, it is possible to create the data structure representation 4 from the ladder diagram L3 and create the ladder diagram L3 from the data structure representation 4.

The circuit elements of the ladder diagram L3 and the data structure representation 4 in FIG. 2 are X1, X2, X3, and X4 (contacts) and Y10 (coil). X1 and X2 form a series circuit. A hierarchy analysis unit 13 expresses the series circuit composed of X1 and X2 as (X1 and X2), which is a hierarchical unit. (X1 and X2) and X3 form a parallel circuit. The hierarchy analysis unit 13 expresses the parallel circuit composed of (X1 and X2) and X3 as ((X1 and X2) or X3), which is also a hierarchical unit.

By displaying series circuits and parallel circuits in such a manner, the ladder diagram L3 can be expressed by a data structure representation (A) as described below.
(((X1 and X2) or X3) and X4 and Y10) (A)

The data structure representation (A) here is the data structure representation 4 in FIG. 2. In the present embodiment, the hierarchical data retaining unit 12 stores in advance the data structure representation 4. The display processing unit 14A reads the data structure representation 4 from the hierarchical data retaining unit 12 and causes the ladder diagram corresponding to the data structure representation 4 to be displayed on the display unit 30.

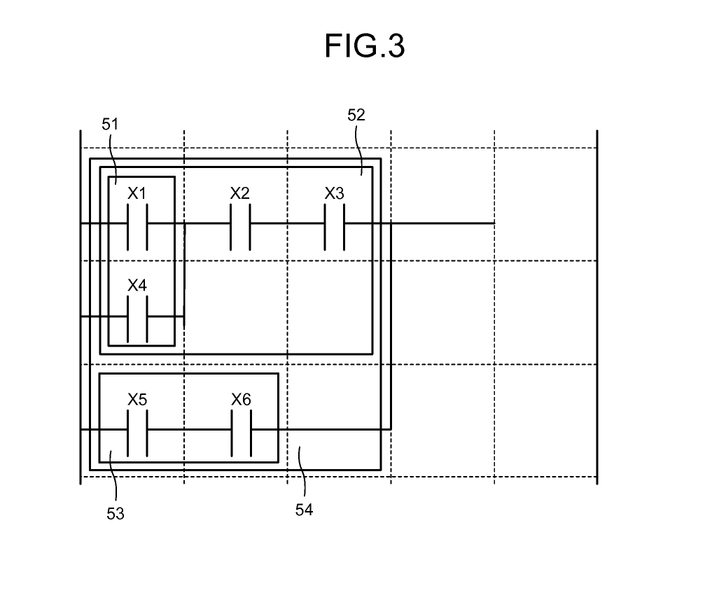

FIG. 3 is a diagram for explaining a method of displaying a ladder diagram. The display processing unit 14A causes parallel circuits, series circuits, and connection lines to be displayed on the display unit 30 as a ladder diagram on the basis of the data structure representation 4 in accordance with the following rules:

(Rule 1) A series circuit block is expressed by arranging hierarchical units in the horizontal direction (right and left direction).

(Rule 2) A parallel circuit block is expressed by arranging hierarchical units in the vertical direction (up and down direction).

(Rule 3) When connected hierarchical units are not adjacent to each other, the connection relation is expressed by adding a connection line.

The display processing unit 14A causes a ladder program to be displayed on the display unit 30 as a ladder diagram on a two-dimensional grid by following (Rule 1) to (Rule 3) described above. According to (Rule 1) to (Rule 3) described above, the display processing unit 14A can display a data structure representation (B) described below as illustrated in FIGS. 3.
(((X1 or X4) and X2 and X3) or (X5 and X6)) (B)

At this point, the display processing unit 14A causes the ladder program having the data structure representation (B) to be displayed on the display unit 30 as a ladder diagram by analyzing the content of the three brackets in the data structure representation (B) starting from the innermost bracket. Specifically, the display processing unit 14A performs the following processes:

(Process 1-1) The hierarchical unit (X1 or X4) is arranged vertically at the upper left position of the screen so as to display a parallel circuit block 51 composed of (X1 or X4).

(Process 1-2) The hierarchical unit “and X2 and X3” is arranged on the right side of the parallel circuit block 51 so as to display a series circuit block 52 composed of ((X1 or X4) and X2 and X3).

(Process 1-3) The hierarchical unit (X5 and X6) is arranged horizontally so as to generate a series circuit block 53.

(Process 1-4) A connection line 54 is added to the right side of X6 in order to connect ((X1 or X4) and X2 and X3) and (X5 and X6) in parallel.

When the display processing unit 14A in the present embodiment displays each hierarchy, the display processing unit 14A color-codes each hierarchy. In other words, the display processing unit 14A colors each hierarchical unit in a different color. The color-coded indication process performed in hierarchical units is explained here.

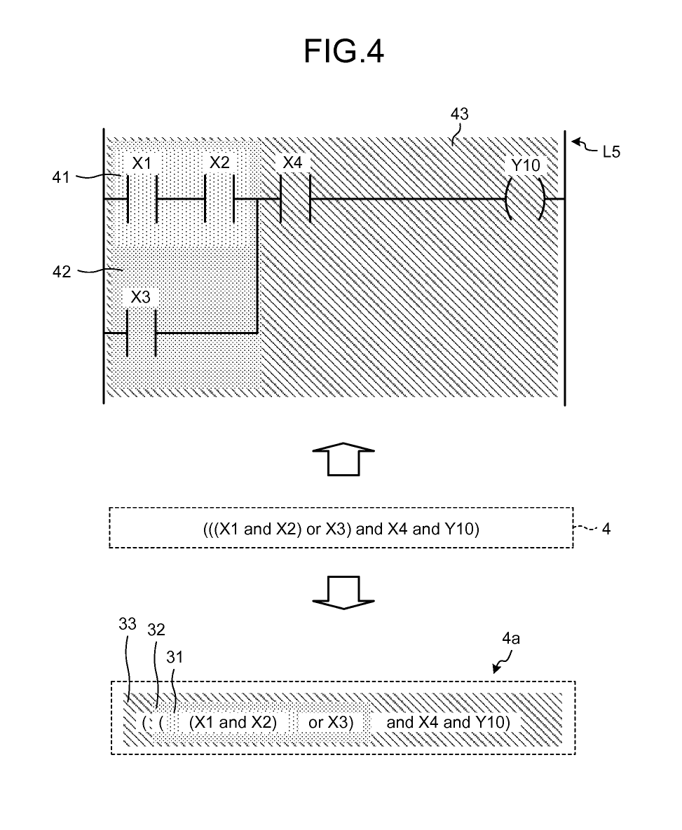

FIG. 4 is a diagram for explaining the color-coded indication process performed in hierarchical units. An explanation will be given here of a case where the display processing unit 14A causes the data structure representation 4 to be displayed in a color-coded manner as a ladder diagram L5 or a data structure representation 4a.

First, an explanation will be given of a case where the data structure representation 4 is displayed in a color-coded manner as the ladder diagram L5. The data structure representation 4 is configured from circuit units (a series circuit block 31, a parallel circuit block 32, and a series circuit block 33). The display processing unit 14A causes the data structure representation 4 to be displayed as the ladder diagram L5 by using a method explained with reference to FIG. 3.

In this case, the display processing unit 14A causes the series circuit block 31 to be displayed on the display unit 30 as a series circuit block 41 of the ladder diagram L5. In a similar manner, the display processing unit 14A causes the parallel circuit block 32 to be displayed as a parallel circuit block 42 of the ladder diagram L5 and causes the series circuit block 33 to be displayed as a series circuit block 43 of the ladder diagram L5. Specifically, the display processing unit 14A performs the following processes:

(Process 2-1) (X1 and X2): (X1 and X2) is a hierarchical unit of a series circuit; therefore, it is displayed in a horizontal arrangement on the upper left of the screen.

(Process 2-2) “or X3”: “or X3” is a hierarchical unit of a parallel circuit; therefore, X3 is displayed in an arrangement under the series circuit block 41.

(Process 2-3) “connection line”: a connection line is added to the right side of X3 in order to connect X3 and (X1 and X2).

(Process 2-4) “and X4 and Y10”: “and X4 and Y10” is a hierarchical unit of a series circuit; therefore, X4 and Y10 are displayed in an arrangement on the right side of the parallel circuit block 42.

The display processing unit 14A automatically performs a display process of putting a coil to the right side.

Furthermore, the display processing unit 14A color-codes each hierarchical unit of the ladder diagram L5. For example, the display processing unit 14A colors the series circuit block 41, which is the first hierarchy, in the first color (such as yellow). Moreover, the display processing unit 14A colors the parallel circuit block 42 (annular area), which is the second hierarchy, in the second color (such as green). Furthermore, the display processing unit 14A colors the series circuit block 43 (annular area), which is the third hierarchy, in the third color (such as light blue).

Next, an explanation will be given of a case where the data structure representation 4 is displayed in a color-coded manner as the data structure representation 4a. For example, the display processing unit 14A colors the series circuit block 31, which is the first hierarchy, in the first color and colors the parallel circuit block 32 (annular area), which is the second hierarchy, in the second color. Furthermore, the display processing unit 14A colors the series circuit block 33 (annular area), which is the third hierarchy, in the third color.

In such a manner, the display processing unit 14A color-codes each hierarchical unit. At this point, the display processing unit 14A may color-code each hierarchical unit with a margin (gap) being provided between a hierarchical unit and an upper hierarchical unit thereof.

Specifically, the display processing unit 14A causes the border line of the series circuit block 41 not to overlap with the parallel circuit block 42 and the series circuit block 43 and causes the border line of the parallel circuit block 42 not to overlap with the series circuit block 43. In other words, the display processing unit 14A arranges each circuit block such that the series circuit block 41 (lower layer side) is located inside the parallel circuit block 42 (upper layer side) and the parallel circuit block 42 (lower layer side) is located inside the series circuit block 43 (upper layer side).

In a similar manner, the display processing unit 14A causes the border line of the series circuit block 31 not to overlap with the parallel circuit block 32 and the series circuit block 33 and causes the border line of the parallel circuit block 32 not to overlap with the series circuit block 33. In other words, the display processing unit 14A displays each circuit block such that the series circuit block 31 (lower layer side) is located inside the parallel circuit block 32 (upper layer side) and the parallel circuit block 32 (lower layer side) is located inside the series circuit block 33 (upper layer side). Consequently, the data structure representation 4a can be displayed such that it is easy to visually recognize the depth of hierarchies.

In the present embodiment, an explanation has been given of a case where the data structure representation 4, which is not color-coded, is stored in advance in the hierarchical data retaining unit 12; however, the data structure representation 4a, which is color-coded, may be stored in advance in the hierarchical data retaining unit 12. Visual identification is not limited to color-coded indication. For example, identification may be performed by using shades of a color, background patterns, flashing, framing, hatching, or the like.

Moreover, the display processing unit 14A may cause the depth of a circuit in the hierarchical structure (the depth of a hierarchical unit in the hierarchical structure) (in which layer number the hierarchical unit is present) to be displayed on the display unit 30 as quality information on a ladder program. The depth in the hierarchical structure indicates the hierarchical position of a hierarchical unit in a ladder program. The display processing unit 14A derives the depth of a hierarchical unit in the hierarchical structure on the basis of the number of brackets on the inner or outer side of the hierarchical unit. The display processing unit 14A may cause the derived depth in the hierarchical structure to be displayed near all of the hierarchical units or near the set hierarchical unit.

When a plurality of the same circuit blocks are present within one hierarchical unit, the display processing unit 14A may highlight the same circuit blocks. When there are hierarchical units that are each composed of the same circuit block in a ladder program, the display processing unit 14A may highlight these hierarchical units.

As described above, according to the first embodiment, each circuit logical hierarchical unit in a ladder program is color-coded; therefore, it is possible to easily recognize in which hierarchy of the entire ladder diagram each component of the ladder diagram is located. In other words, it is possible to display a ladder program such that the hierarchical structure thereof (the hierarchical range and the depth between hierarchies) is easily visible.

Therefore, if the program display in the present embodiment is used for a ladder-program creation operation, it is possible to easily recognize in which hierarchy of the entire ladder program the currently selected portion is located. Therefore, the program creation operation can be made efficient. Moreover, an operation can be collectively performed in logically united units by performing an operation in hierarchical units. Therefore, the program creation operation can be made more efficient. Moreover, for example, it is possible to prevent faults due to the misreading of a hierarchical range from being contained in a program; therefore, the quality of the program being created can be improved.

### Second Embodiment

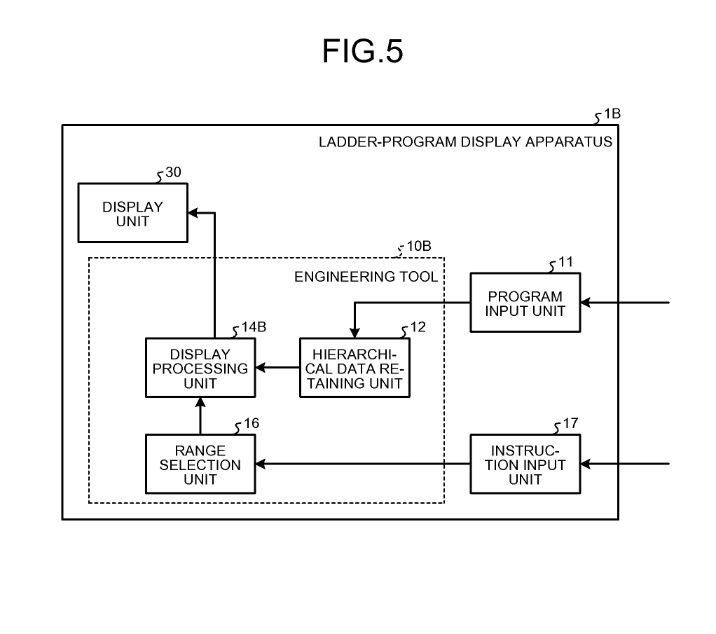

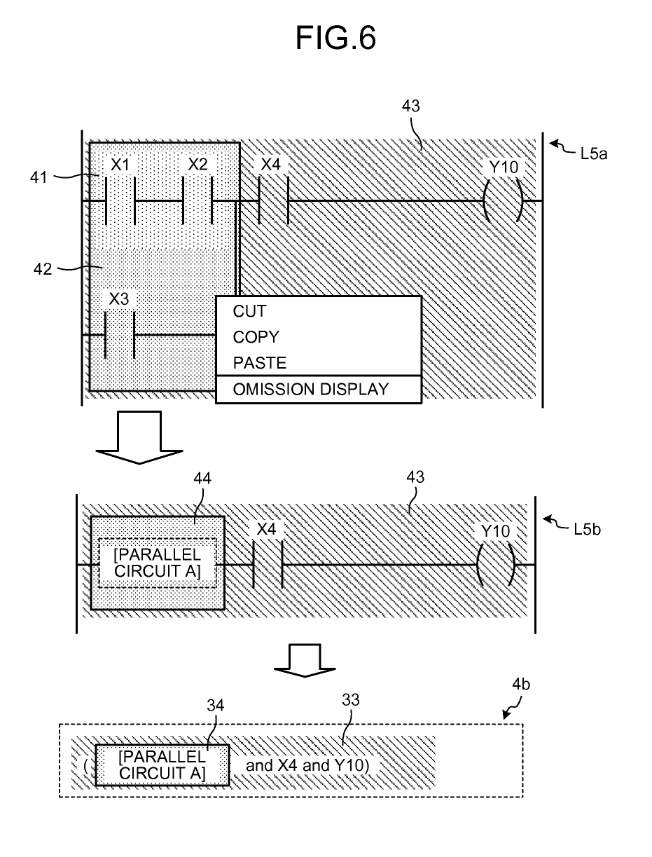

Next, a second embodiment of the present invention will be explained with reference to FIG. 5 and FIG. 6. The second embodiment introduces a system of enabling a hierarchical unit to be selected as a selection range. With this system, omission display is performed in hierarchical units.

FIG. 5 is a diagram illustrating the configuration of a ladder-program display apparatus according to the second embodiment. Among the components in FIG. 5, the components that achieve the same functions as those of the ladder-program display apparatus 1A in the first embodiment illustrated in FIG. 1 are designated by the same reference numerals and redundant explanation is omitted.

A ladder-program display apparatus 1B includes an instruction input unit 17 and a range selection unit (target setting unit) 16 in addition to the functions of the ladder-program display apparatus 1A. Moreover, the ladder-program display apparatus 1B includes an engineering tool 10B instead of the engineering tool 10A. The engineering tool 10B includes the range selection unit 16 in addition to the components of the engineering tool 10A. The engineering tool 10B in the present embodiment has a function as an omission display tool. Moreover, the ladder-program display apparatus 1B includes a display processing unit 14B instead of the display processing unit 14A.

The instruction input unit 17 is connected to the range selection unit 16. The instruction input unit 17 receives an instruction from the user and sends the instruction to the range selection unit 16. The instruction from the user is an instruction (hereinafter, referred to as a hierarchy specifying instruction) specifying a hierarchical unit that is to be operated (to be processed) or an instruction (hereinafter, referred to as an omission display instruction) to perform omission display.

The range selection unit 16 is connected to the display processing unit 14B. The range selection unit 16 has a function of switching the range to be operated in hierarchical units. When any hierarchical unit is specified via the instruction input unit 17 (when a hierarchy specifying instruction is input), the range selection unit 16 sets the specified hierarchical unit as a selection range. The range selection unit 16 sends the set selection range (hierarchical unit) to the display processing unit 14B. Moreover, when an omission display instruction is input, the range selection unit 16 sends an instruction to display the set selection range in an omitted manner to the display processing unit 14B.

The display processing unit 14B in the present embodiment has a function similar to that of the display processing unit 14A and a function of displaying the set selection range in an omitted manner in accordance with the instruction from the range selection unit 16. When the information concerning the set selection range is sent from the range selection unit 16, the display processing unit 14B may display the set selection range such that it can be identified. For example, the display processing unit 14B may change the color of the set selection range to a color (a color different from those of other portions) indicating the set selection range.

Next, the omission display process performed on a selection range will be explained. FIG. 6 is a diagram for explaining the omission display process performed on a selection range. A ladder diagram L5a illustrated in FIG. 6 is a ladder diagram similar to the ladder diagram L5 illustrated in FIG. 4.

In the ladder diagram L5a, when the user specifies, for example, the parallel circuit block 42, the hierarchy specifying instruction specifying the parallel circuit block 42 is input to the instruction input unit 17. For example, the hierarchy specifying instruction is input to the instruction input unit 17 by the user clicking the mouse on any position in the parallel circuit block 42 and other than the series circuit block 41. In other words, the hierarchy specifying instruction specifying the parallel circuit block 42 is input to the instruction input unit 17 by specifying any position in the area (rectangular annular area) excluding the area of the series circuit block 41 from the area of the parallel circuit block 42.

For example, when a position inside the contact X1 is specified, the instruction input unit 17 determines that the contact X1 is specified. When a position that is inside the series circuit block 41 and is outside the contacts X1 and X2 is specified, the instruction input unit 17 determines that the series circuit block 41 (X1 and X2) is specified.

The selection operation can be also performed with keystrokes. For example, the selection range may be moved to an upper hierarchical unit by pressing the shift key and the cursor up key and may be moved to a lower hierarchical unit by pressing the shift key and the cursor down key.

The instruction input unit 17 sends the specified hierarchy specifying instruction to the range selection unit 16. Then, the range selection unit 16 sets the hierarchical unit specified by the hierarchy specifying instruction as a selection range. For example, when the parallel circuit block 42 is specified, the range selection unit 16 sets the hierarchical unit of the parallel circuit block 42 as a selection range and, when the series circuit block 43 is specified, the range selection unit 16 sets the hierarchical unit of the series circuit block 43 as a selection range.

The range selection unit 16 then sends the set selection range to the display processing unit 14B. Accordingly, the display processing unit 14B displays the set selection range such that it can be distinguished from the selection ranges that are not set. The display processing unit 14B, for example, colors the set selection range. The display processing unit 14B may surround the set selection range with a frame or may make the set selection range flash.

Thereafter, when the user performs an operation, such as a right click, the instruction corresponding to this operation is sent to the display processing unit 14B via the instruction input unit 17 and the range selection unit 16. Consequently, the display processing unit 14B causes an edit menu to be displayed. Cut, copy, paste, omission display, and the like are set in the edit menu.

When the user specifies omission display of the selection range, the instruction corresponding to this specified operation is sent to the display processing unit 14B via the instruction input unit 17 and the range selection unit 16. Accordingly, the display processing unit 14B causes the set hierarchical unit to be displayed in an omitted manner on the display unit 30.

For example, the display processing unit 14B causes a circuit unit (circuit block) to be displayed in an omitted manner on the display unit 30 by displaying the circuit unit in a smaller area than the area in which its original structure is displayed. The display processing unit 14B may cause the internal structure to be displayed in an omitted manner on the display unit 30. The display processing unit 14B may cause a circuit unit to be displayed in an omitted manner on the display unit 30 by displaying, for example, a character string representing the role or meaning of the circuit unit as an alternative representation of the circuit unit.

FIG. 6 illustrates a ladder diagram L5b when the display processing unit 14B causes the display unit 30 to display a character string 44 “parallel circuit A” as an alternative representation of the parallel circuit block 42. The ladder diagram L5a is displayed in such a manner in an omitted manner as the ladder diagram L5b.

The omission display in the ladder diagram L5b may be reflected in the data structure representation 4a. FIG. 6 illustrates a data structure representation 4b when the display processing unit 14B causes the display unit 30 to display a character string 34 “parallel circuit A” as an alternative representation of the parallel circuit block 32, which is a circuit unit. The data structure representation 4a is displayed in such a manner in an omitted manner as the data structure representation 4b.

The data structure representation 4b may be generated by using the data structure representation 4a. In other words, the display processing unit 14B may generate the data structure representation 4b from the data structure representation 4a by the user issuing an omission display instruction to the data structure representation 4a. In this case, the display processing unit 14B generates the data structure representation 4b from the data structure representation 4a without generating the ladder diagram L5b.

In the present embodiment, an explanation has been given of a case where each hierarchical unit is color-coded; however, the omission display may be performed in hierarchical units without color-coding each hierarchical unit. The display processing unit 14B may cause the hierarchical data retaining unit 12 to store in advance the ladder diagram L5b or the data structure representation 4b that is displayed in an omitted manner.

As described above, according to the second embodiment, because the range to be operated is switched in hierarchical units, the user can specify a hierarchical unit or display a hierarchical unit in an omitted manner with less time and effort than the conventional operations. Moreover, a hierarchical unit is easily displayed in an omitted manner; therefore, the legibility of the entire program is improved.

### Third Embodiment

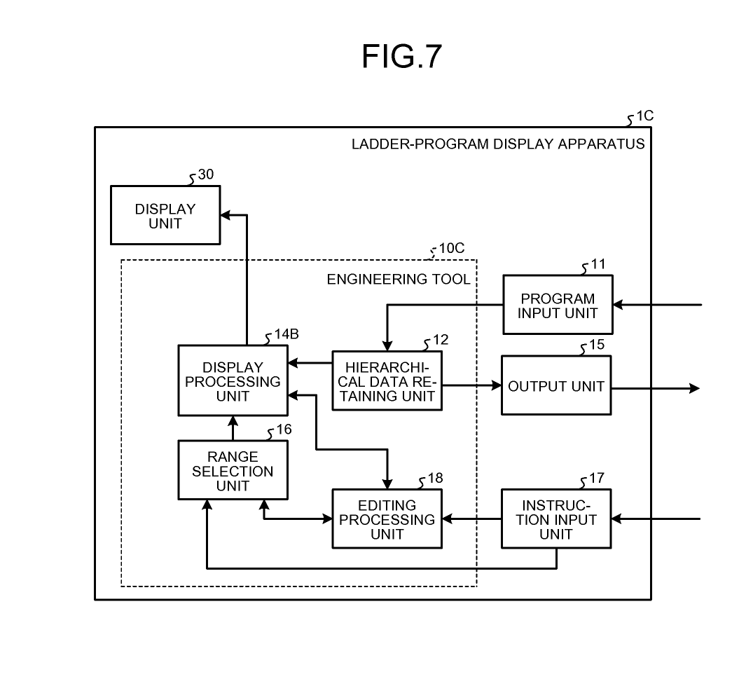

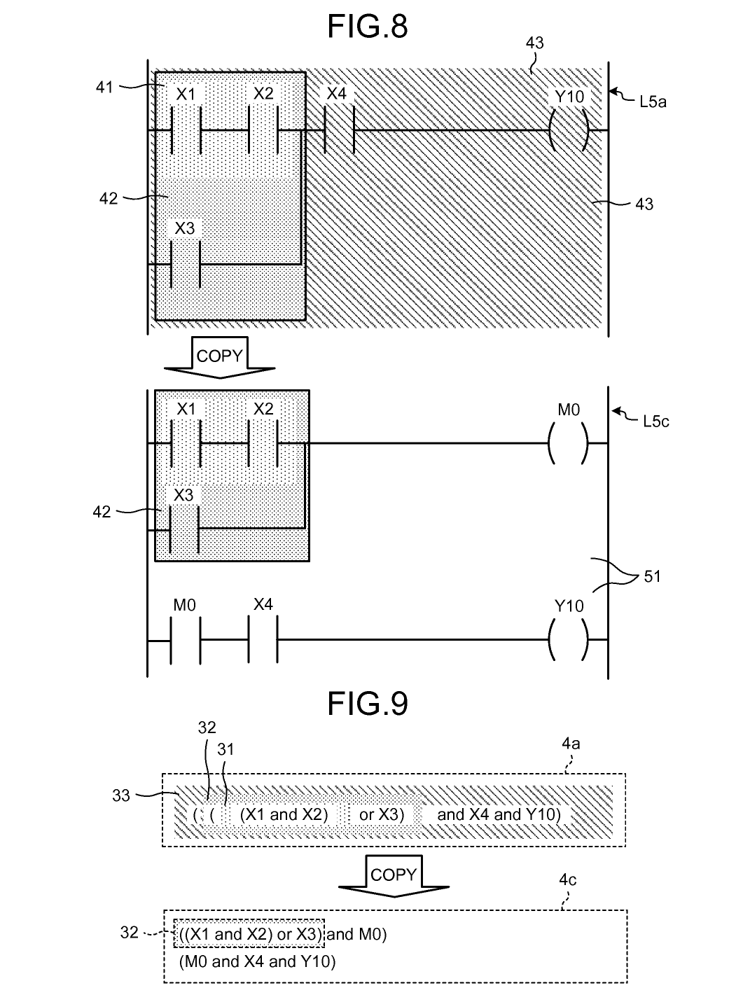

Next, a third embodiment of the present invention will be explained with reference to FIG. 7 and FIG. 8. The third embodiment introduces a system of performing an editing process, such as batch delete, copy, paste of a selected hierarchical unit. Accordingly, batch edit is performed in logically united units (hierarchical units).

FIG. 7 is a diagram illustrating the configuration of a ladder-program display apparatus according to the third embodiment. Among the components in FIG. 7, the components that achieve the same functions as those of the ladder-program display apparatus 1B in the second embodiment illustrated in FIG. 5 are designated by the same reference numerals and redundant explanation is omitted.

A ladder-program display apparatus 1C includes an editing processing unit 18 and an output unit 15 in addition to the functions of the ladder-program display apparatus 1B. Moreover, the ladder-program display apparatus 1C includes an engineering tool 10C instead of the engineering tool 10B. The engineering tool 10C includes the editing processing unit 18 in addition to the components of the engineering tool 10B. The engineering tool 10C in the present embodiment has a function as a display editing tool.

The editing processing unit 18 is connected to the instruction input unit 17, the range selection unit 16, and the display processing unit 14B. When the user performs an editing operation on a hierarchical unit that is set by the range selection unit 16, the editing processing unit 18 changes the data structure representation 4a in the hierarchical data retaining unit 12 in accordance with the operation content.

The output unit 15 is connected to the hierarchical data retaining unit 12. When the output unit 15 receives an instruction to output a data structure representation in the hierarchical data retaining unit 12, the output unit 15 outputs the data structure representation in the hierarchical data retaining unit 12 to an external device.

When the user performs an operation corresponding to the editing instruction, the instruction input unit 17 in the present embodiment sends the editing instruction to the editing processing unit 18. The editing instruction is, for example, delete, copy, or paste.

Next, the editing process performed in hierarchical units is explained. FIG. 8 is a diagram for explaining the process of editing a ladder diagram in hierarchical units. In this embodiment, an explanation will be given of a process where the ladder-program display apparatus 1C generates a ladder diagram L5c using a part (the parallel circuit block 42) of the ladder diagram L5a.

The range selection unit 16 sets the hierarchical unit (the parallel circuit block 42) specified by the hierarchy specifying instruction as a selection range. Then, the range selection unit 16 sends the set selection range to the display processing unit 14B. Then, the display processing unit 14B displays the set selection range such that it can be distinguished from the selection ranges that are not set.

Furthermore, the range selection unit 16 sends the set hierarchical unit to the editing processing unit 18. Thereafter, when the user inputs, from the instruction input unit 17, an editing operation (delete, copy, paste, or the like) for the hierarchical unit that is set by the range selection unit 16, the editing processing unit 18 performs, in accordance with the content of the editing operation, the editing process using the set hierarchical unit. Specifically, the editing processing unit 18 performs copy, delete, or the like in hierarchical units on the ladder diagram that is being displayed. When the editing operation is paste, the pasting position is specified as the editing operation; therefore, the editing processing unit 18 pastes the set hierarchical unit at the specified pasting position. FIG. 8 illustrates a case where the editing processing unit 18 copies and pastes the parallel circuit block 42 to the ladder diagram L5c.

Thereafter, the ladder-program display apparatus 1C repeats the editing process in accordance with the instruction from the user. When the user inputs an editing complete instruction to the instruction input unit 17, this instruction is sent to the display processing unit 14B via the editing processing unit 18. Then, the display processing unit 14B causes the hierarchical data retaining unit 12 to store the ladder diagram L5c, which is the edited ladder program.

FIG. 9 is a diagram for explaining the process of editing a data structure representation in hierarchical units. In this embodiment, an explanation will be given of a process where the ladder-program display apparatus 1C generates the data structure representation 4c by using a part of the data structure representation 4a.

The range selection unit 16 sets the hierarchical unit (the parallel circuit block 32) specified by the hierarchy specifying instruction as a selection range. Then, the range selection unit 16 sends the set selection range to the display processing unit 14B. Then, the display processing unit 4B displays the set selection range such that it can be distinguished from the selection ranges that are not set.

Furthermore, the range selection unit 16 sends the set hierarchical unit to the editing processing unit 18. Thereafter, when the user inputs, from the instruction input unit 17, an editing operation (delete, copy, paste, or the like) for the hierarchical unit that is set by the range selection unit 16, the editing processing unit 18 performs, in accordance with the content of the editing operation, the editing process using the set hierarchical unit. Specifically, the editing processing unit 18 performs copy, delete, or the like in hierarchical units on the data structure representation that is being displayed. When the editing operation is paste, the pasting position is specified as the editing operation; therefore, the editing processing unit 18 pastes the set hierarchical unit at the specified pasting position. FIG. 9 illustrates a case where the editing processing unit 18 copies and pastes the parallel circuit block 32 to the data structure representation 4c. The editing processing unit 18 may perform search, replace, or the like as the editing operation.

Thereafter, the ladder-program display apparatus 1C repeats the editing process in accordance with the instruction from the user. When the user inputs an editing complete instruction to the instruction input unit 17, this instruction is sent to the display processing unit 14B via the editing processing unit 18. Then, the display processing unit 14B causes the hierarchical data retaining unit 12 to store the data structure representation 4c, which is the edited ladder program. In the present embodiment, an explanation has been given of a case where each hierarchical unit is color-coded; however, the editing process may be performed in hierarchical units without color-coding each hierarchical unit.

As described above, according to the third embodiment, the editing operation can be collectively performed by using the selection range specifying a logical hierarchical unit; therefore, the editing process can be easily performed in logically united units. Therefore, the program creation operation and the editing operation can be made efficient.

### Fourth Embodiment

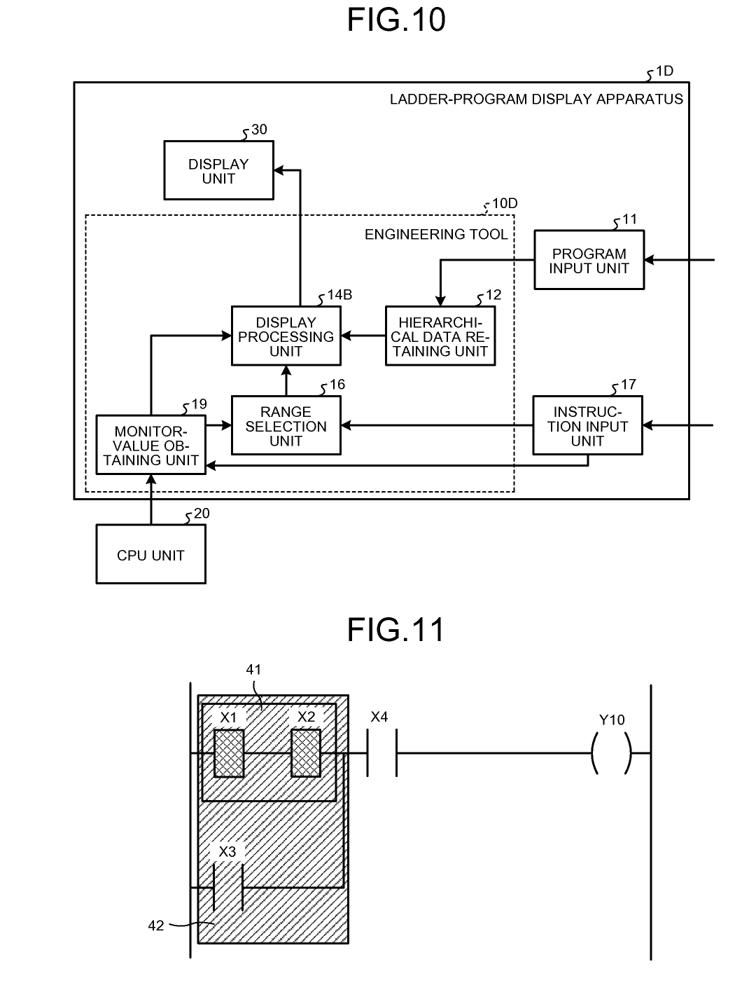

Next, a fourth embodiment of the present invention will be explained with reference to FIG. 10 to FIG. 11. The fourth embodiment introduces a system of obtaining current values of only the valuables included in the selected hierarchical unit (partial circuit) from the CPU unit. With this system, the execution state is individually displayed on the monitor in logically united units.

FIG. 10 is a diagram illustrating the configuration of a ladder-program display apparatus according to the fourth embodiment. Among the components in FIG. 10, the components that achieve the same functions as those of the ladder-program display apparatus 1B in the second embodiment illustrated in FIG. 5 are designated by the same reference numerals and redundant explanation is omitted.

A ladder-program display apparatus 1D includes a monitor-value obtaining unit 19 in addition to the functions of the ladder-program display apparatus 1B. Moreover, the ladder-program display apparatus 1D includes an engineering tool 10D instead of the engineering tool 10B. The engineering tool 10D includes the monitor-value obtaining unit 19 in addition to the components of the engineering tool 10B. The engineering tool 10D is connected to a CPU unit 20. The engineering tool 10D in the present embodiment has a function as a monitor tool.

The monitor-value obtaining unit 19 is connected to the display processing unit 14B, the range selection unit 16, the instruction input unit 17, and the CPU unit 20. When the monitor-value obtaining unit 19 receives an instruction to display the selection range on the monitor from the user, the monitor-value obtaining unit 19 obtains the set hierarchical unit from the range selection unit 16 and generates a list of variables within the selection range. Moreover, the monitor-value obtaining unit 19 obtains the current values in the variable list from the CPU unit 20 that is being executed. In other words, the monitor-value obtaining unit 19 obtains, from the CPU unit 20, the monitor values of only the variables included in the set hierarchical unit. Furthermore, the monitor-value obtaining unit 19 instructs (monitor display instruction) the display processing unit 14B to display the selection range in the state according to the obtained current values of the variables.

The CPU unit 20 is a processing unit that executes a ladder program and is a unit that includes a CPU that operates in accordance with the ladder program. When the CPU unit 20 executes the ladder program, the CPU unit 20 outputs the conduction state (execution state) to the monitor-value obtaining unit 19.

The display processing unit 14B in the present embodiment causes the ladder diagram to be displayed on the display unit 30 in accordance with the instruction from the monitor-value obtaining unit 19 such that the conduction state can be recognized in hierarchical units. Specifically, the display processing unit 14B causes the ladder diagram to be displayed such that it is possible to determine whether the circuits in the specified hierarchical unit and the specified hierarchical unit itself are conductive in accordance with the current values of the variables. For example, the display processing unit 14B expresses the conduction state of a circuit element that is conducting by coloring the circuit element in a color (for example, light blue) that is different from that of other portions. Moreover, for example, the display processing unit 14B expresses the conduction state of a hierarchical unit that is conducting by coloring the hierarchical unit in a color (for example, brown) that is different from that of other portions.

In monitor display in the conventional technologies, the entire ladder program is displayed as a unit on the monitor. Therefore, there is a problem in that the performance is reduced as the number of variables whose conduction state is obtained and displayed increases. Moreover, when it is desired to focus on and monitor the state of only a partial circuit, if the entire ladder program is displayed on the monitor, there is a problem with legibility. For example, it is difficult to find the partial circuit that is desired to be focused on.

In the present embodiment, the ladder-program display apparatus 1D displays a ladder diagram such that the conduction state can be recognized in hierarchical units. Moreover, the ladder-program display apparatus 1D colors and displays a circuit element and a hierarchical unit that are conducting.

FIG. 11 is a diagram for explaining monitor display in hierarchical units. FIG. 11 illustrates a ladder diagram when the user selects the hierarchical unit of the parallel circuit block 42 and only the selection range is displayed on the monitor.

An instruction (selection range monitor instruction) to display only the range (hierarchical unit) selected by the user on the monitor is input to the instruction input unit 17. The instruction input unit 17 sends the input selection range monitor instruction to the monitor-value obtaining unit 19.

When the monitor-value obtaining unit 19 receives the selection range monitor instruction, the monitor-value obtaining unit 19 obtains the set hierarchical unit from the range selection unit 16 and generates a variable list within the hierarchical unit (within the range). When the range selection unit 16 sets the parallel circuit block 42 as a selection range, the monitor-value obtaining unit 19 generates [X1, X2, X3] as a variable list.

Then, the monitor-value obtaining unit 19 obtains the current values in the variable list from the CPU unit 20 that is being executed. For example, the monitor-value obtaining unit 19 obtains the current values such as [X1=ON, X2=ON, X3=OFF]. The monitor-value obtaining unit 19 sends the monitor display instruction to the display processing unit 14B such that the set selection range is displayed in the state according to the obtained current values of the variables.

When the display processing unit 14B receives the monitor display instruction, the display processing unit 14B causes the display unit 30 to display the circuits such that it is possible to identify which circuit is conducting in accordance with the current values of the variables. The display processing unit 14B displays, for example, circuit elements (contacts X1 and X2) that are conducting in color. Moreover, the display processing unit 14B displays a hierarchical unit that is conducting with hatching.

As described above, according to the fourth embodiment, a monitor display target can be specified in logical circuit hierarchical units; therefore, each hierarchical unit can be individually displayed on the monitor. Therefore, it is possible to limit the number of variables whose conduction state is obtained. As a result, the conduction-state display performance and the processing performance are improved. Moreover, it is possible to specify only a hierarchical unit on which there is a desire to be focused and monitor the conduction state of the hierarchical unit; therefore, the legibility of the monitor is improved. Thus, debugging of a ladder program can be performed efficiently.

### Fifth Embodiment

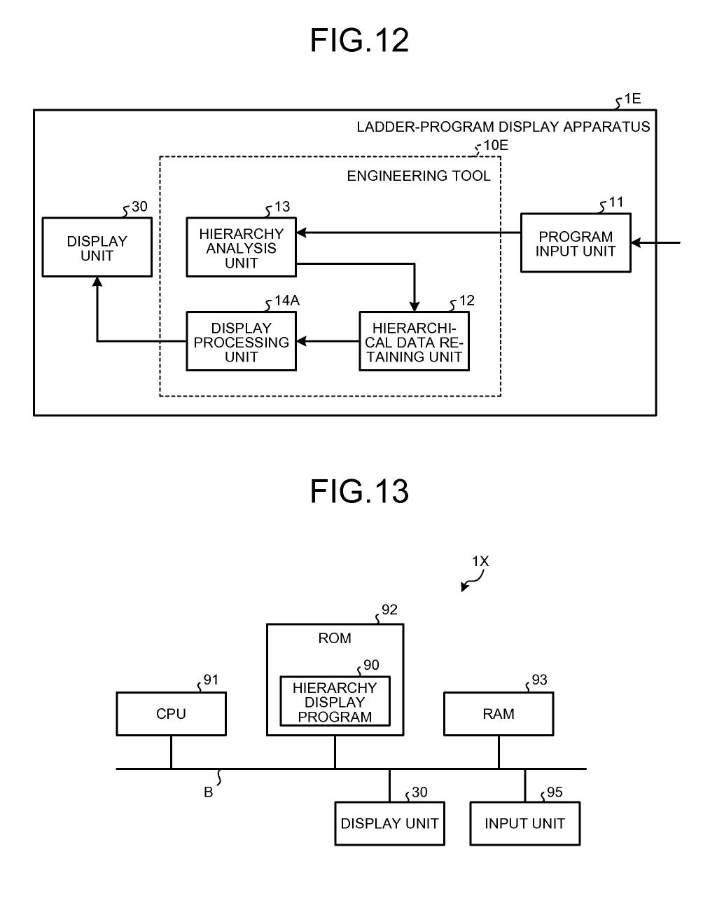

Next, a fifth embodiment of the present invention will be explained with reference to FIG. 12 and FIG. 13. In the fifth embodiment, when a ladder diagram is input to a ladder-program display apparatus, the ladder-program display apparatus analyzes the ladder diagram and converts the ladder diagram into a data structure representation.

FIG. 12 is a diagram illustrating the configuration of a ladder-program display apparatus according to the fifth embodiment. Among the components in FIG. 12, the components that achieve the same functions as those of the ladder-program display apparatus 1A in the first embodiment illustrated in FIG. 1 are designated by the same reference numerals and redundant explanation is omitted.

A ladder-program display apparatus 1E includes the hierarchy analysis unit 13 in addition to the functions of the ladder-program display apparatus 1A. Moreover, the ladder-program display apparatus 1D includes an engineering tool 10E instead of the engineering tool 10A. The engineering tool 10E includes the hierarchy analysis unit 13 in addition to the components of the engineering tool 10A. The engineering tool 10E in the present embodiment has a function as a monitor tool.

The program input unit 11 receives a ladder diagram L3 created by a ladder-program creating apparatus or the like and sends the ladder diagram L3 to the hierarchy analysis unit 13. The hierarchy analysis unit 13 analyzes the hierarchical structure of the series and parallel circuits arranged in the ladder diagram L3. The hierarchy analysis unit 13 provides the hierarchical structure to a ladder program on the basis of the analysis result. Specifically, the hierarchy analysis unit 13 generates the data structure representation 4 on the basis of the ladder diagram L3. The hierarchy analysis unit 13 causes the hierarchical data retaining unit 12 to store the data structure representation 4 including the information on the hierarchical structure.

The display processing unit 14A displays the ladder diagram L5 such that each hierarchical unit can be visually identified on the basis of the data structure representation 4 in the hierarchical data retaining unit 12. The display processing unit 14A displays the ladder diagram L5 in a color-coded manner by performing a process similar to that in the first embodiment.

In the present embodiment, an explanation has been given of a case where the ladder diagram L5 is displayed in a color-coded manner on the basis of the data structure representation 4; however, the ladder diagram L5 may be displayed in a color-coded manner on the basis of the data structure representation 4 and the ladder diagram L3. In this case, the data structure representation 4 and the ladder diagram L3 are stored in the hierarchical data retaining unit 12.

Next, the hardware configuration of the ladder-program display apparatuses 1A to 1E will be explained. FIG. 13 is a diagram illustrating the hardware configuration of a ladder-program display apparatus. A ladder-program display apparatus 1X illustrated in FIG. 13 is any of the ladder-program display apparatuses 1A to 1E.

The ladder-program display apparatus 1X includes a CPU (Central Processing unit) 91, a ROM (Read Only Memory) 92, a RAM (Random Access Memory) 93, the display unit 30, and an input unit 95. In the ladder-program display apparatus 1X, the CPU 91, the ROM 92, the RAM 93, the display unit 30, and the input unit 95 are connected via a bus line B.

The CPU 91 displays each hierarchical unit in a ladder program in a color-coded manner by using a hierarchy display program 90 that is a computer program. The display unit 30 is a display device, such as a liquid crystal monitor, and displays a ladder diagram, a data structure representation, and the like in a color-coded manner in accordance with an instruction from the CPU 91. The input unit 95 is configured to include as a mouse and a keyboard, and receives instruction information that is externally input from the user, a ladder program, and the like. The instruction information input to the input unit 95 is sent to the CPU 91.

The hierarchy display program 90 is stored in the ROM 92 and is loaded in the RAM 93 via the bus line B. The CPU 91 executes the hierarchy display program 90 loaded in the RAM 93. Specifically, in the ladder-program display apparatus 1X, in accordance with the instruction input by the user via the input unit 95, the CPU 91 reads the hierarchy display program 90 from the ROM 92, loads the hierarchy display program 90 in a program storage area in the RAM 93, and executes various processes. The CPU 91 temporarily stores various data generated in the various processes in a data storage area formed in the RAM 93.

The hierarchy display program 90 executed in the ladder-program display apparatus 1X is configured from modules including the hierarchical data retaining unit 12, the display processing unit 14A (the display processing unit 14B), and the like, and they are loaded in the main memory to be generated in the main memory.

As described above, according to the fifth embodiment, the data structure representation 4 is generated from the ladder diagram L3; therefore, even when the ladder program input to the ladder-program display apparatus 1E is a ladder diagram, the ladder diagram can be displayed in a color-coded manner.

### INDUSTRIAL APPLICABILITY

As described above, the ladder-program display apparatus and the ladder-program display program according to the present invention are suitable for displaying circuits in a ladder program.

### REFERENCE SIGNS LIST

1A to 1E, 1X ladder-program display apparatus, 4, 4a to 4c data structure representation, 10A to 10E engineering tool, 11 program input unit, 12 hierarchical data retaining unit, 13 hierarchy analysis unit, 14A, 14B display processing unit, 15 output unit, 16 range selection unit, 17 instruction input unit, 18 editing processing unit, 19 monitor-value obtaining unit, 20 CPU unit, 30 display unit, 31, 33, 41, 43, 52, 53 series circuit block, 32, 42, 51 parallel circuit block, 90 hierarchy display program, L3, L5, L5a to L5c ladder diagram.

1. A ladder-program display program that causes a computer to execute:
a hierarchical data retaining step of storing a ladder program in a form of a data structure representation that expresses the ladder program by a logical hierarchical structure by expressing each circuit block, which is a hierarchical unit of the ladder program, by a logical expression; and
a display processing step of causing, on a basis of the data structure representation, the ladder program to be displayed on a display device in a form of a data structure representation or a ladder diagram in which each hierarchical unit of the hierarchical structure is visually capable of being identified.

2. The ladder-program display program according to claim 1, wherein the display processing step includes causing each hierarchical unit of the hierarchical structure to be displayed in a different color.

3. The ladder-program display program according to claim 1, further causing a computer to execute a target setting step of setting a hierarchical unit specified by a user as a processing target, wherein
the display processing step includes causing a hierarchical unit set as a processing target to be displayed such that the hierarchical unit is capable of being distinguished from a hierarchical unit that is not set as a processing target.

4. The ladder-program display program according to claim 1, further causing a computer to execute:
a target setting step of setting a hierarchical unit specified by a user as a processing target; and
an omission displaying step of causing the hierarchical unit set as a processing target to be displayed in an omitted manner in the ladder program.

5. The ladder-program display program according to claim 1, further causing a computer to execute:
a target setting step of setting a hierarchical unit specified by a user as a processing target; and
an editing step of performing a program editing using the hierarchical unit set as a processing target in accordance with an instruction from a user.

6. The ladder-program display program according to claim 1, further causing a computer to execute:
a target setting step of setting a hierarchical unit specified by a user as a processing target; and
a monitor-value obtaining step of obtaining a monitor value of only a variable included in the hierarchical unit set as a processing target from a processing unit that executes the ladder program, wherein
the display processing step includes causing an execution state of the hierarchical unit set as a processing target to be displayed on a monitor by using the monitor value.

7. The ladder-program display program according to claim 1, wherein the display processing step includes causing a depth of the hierarchical unit in a hierarchical structure to be displayed on the display device.

8. The ladder-program display program according to claim 1, wherein the display processing step includes causing, when a plurality of same circuit blocks are present in one hierarchical unit, the same circuit blocks to be highlighted.

9. The ladder-program display program according to claim 1, wherein the display processing step includes a ladder-diagram generating step of generating the ladder diagram on a basis of the data structure representation.

10. The ladder-program display program according to claim 1, further causing a computer to execute:
an inputting step of inputting a ladder diagram; and
a hierarchy analyzing step of generating a data structure representation corresponding to the ladder diagram by analyzing a hierarchical structure of the ladder diagram, wherein
the hierarchical data retaining step includes storing generated data structure representation.

11. A ladder-program display program that causes a computer to execute:
a hierarchical data retaining step of storing a ladder program in a form of a data structure representation that expresses the ladder program by a logical hierarchical structure by expressing each circuit block, which is a hierarchical unit of the ladder program, by a logical expression;
a display processing step of causing the ladder program to be displayed on a display device in a form of the data structure representation;
a target setting step of setting a hierarchical unit specified by a user as a processing target; and
an editing step of performing a program editing using the hierarchical unit set as a processing target on the ladder program having the data structure representation in accordance with an instruction from a user.

12. A ladder-program display apparatus comprising:
a hierarchical data retaining unit that stores a ladder program in a form of a data structure representation that expresses the ladder program by a logical hierarchical structure by expressing each circuit block, which is a hierarchical unit of the ladder program, by a logical expression; and
a display processing unit that causes, on a basis of the data structure representation, the ladder program to be displayed on a display device in a form of a data structure representation or a ladder diagram in which each hierarchical unit of the hierarchical structure is visually capable of being identified.

13. A ladder-program display apparatus comprising:
a hierarchical data retaining unit that stores a ladder program in a form of a data structure representation that expresses the ladder program by a logical hierarchical structure by expressing each circuit block, which is a hierarchical unit of the ladder program, by a logical expression;
a display processing unit that causes the ladder program to be displayed on a display device in a form of the data structure representation;
a target setting unit that sets a hierarchical unit specified by a user as a processing target; and
an editing unit that performs a program editing using the hierarchical unit set as a processing target on the ladder program having the data structure representation in accordance with an instruction from a user.
